(19) United States
(12) Patent Application Publication
(10) Pub. No.: US 2020/0123985 A1
(43) Pub. Date: Apr. 23, 2020

(54) METHOD AND DEVICE FOR DETERMINING A DAMAGE, WEAR AND/OR UNBALANCE IN A GEARING, IN PARTICULAR A PLANETARY GEARING

(71) Applicant: Rolls-Royce Deutschland Ltd & Co KG, Blankenfelde-Mahlow (DE)

(72) Inventor: Rudolf LÜCK, Rehbruecke (DE)

(21) Appl. No.: 16/605,661

(22) PCT Filed: Apr. 19, 2018
(86) PCT No.: PCT/EP2018/060082

§ 371 Date: Oct. 16, 2019

(30) Foreign Application Priority Data
Apr. 21, 2017 (DE) 10 2017 206 760.8

(51) Int. Cl. F02C 7/36; F02K 3/06

(52) U.S. Cl. CPC F02C 7/36; F16H 1/28; F02K 3/06

(57) ABSTRACT

A method for determining damage, wear and/or imbalance in a transmission configured as a gear transmission, particularly an epicyclic transmission, by means of at least one electronic sensor apparatus, wherein, while the transmission is operating, ensemble averaging is carried out automatically and periodically for measured values or measured value profiles ((P1,n)*_{Sew,i}) which are acquired repeatedly in a phase-synchronous fashion at a measuring point, in order to determine an ensemble average (<s(w)_{ref}>_{P1,n}) for the measuring point. In this context, the ensemble average (<s(w)>*_{P1,n}) is compared with at least one reference value or reference profile (<s(w)_{ref}>_{P1,n}) by means of an electronic evaluation logic in order to output a message about any damage, excessive wear and/or imbalance which has occurred within the transmission in the event of a deviation of the ensemble average (<s(w)>*_{P1,n}) from the at least one reference value or reference profile (<s(w)_{ref}>_{P1,n}) beyond at least one threshold value.

The invention relates to a method and to a device for determining damage, excessive wear and/or imbalance which has occurred within a transmission, particularly an epicyclic transmission.

Epicyclic transmissions, also referred to as planetary transmissions, usually have a centrally arranged sun gear, a plurality of planetary gears which are mounted rotatably on rotating axes and mesh with the sun gear, and an external, internally toothed ring gear. The gears rotating on the rotating axes, e.g. the central sun gear, rotate here similarly to planets around the sun, in order to convert a drive torque of an input shaft, which is connected in a rotationally fixed fashion to the sun gear, into an output torque at an output shaft which—when there is a fixed ring gear—is connected in a rotationally fixed fashion as a spider shaft to the rotating axes of the planetary gears.

Epicyclic transmissions are used, for example, in turbofan engines for aircraft, particularly in so-called geared turbofan engines. The purpose of such an epicyclic transmission is here e.g. to reduce the rotational speed of a turbine shaft (which forms the input shaft of the epicyclic transmission) to a lower rotational speed for a fan of the engine.

Generally in transmissions, but particularly in epicyclic transmissions it is difficult to measure damage, excessive wear and/or imbalance which has occurred within an epicyclic transmission. For example, until now in practice it has not been possible to measure wear of individual teeth of the gearwheels (sun gear, planetary gear, ring gear) of the epicyclic transmission. For example, differences between a damaged and an undamaged tooth or gearwheel cannot be detected, or can only be detected with difficulty, using sensor signals “from the outside” by means of sensors mounted on the epicyclic transmission. Early detection of incipient faults while the transmission is operating is not possible with established technologies.

The invention is therefore based on the object of making available a method and a device in order, in the case of an epicyclic transmission, to shut down easily and quickly during operation, based on sensorially detected measured values or measured value profiles, any damage, excessive wear and/or imbalance which has occurred within the epicyclic transmission.

This object is achieved with a method of claim 1 and a device of claim 20.

According to the invention, a method for determining damage, wear and/or imbalance in a transmission configured as a gear transmission, particularly an epicyclic transmission, by means of at least one electronic sensor apparatus, wherein, while the transmission is operating,
in each case at least measured value or measured value profile for a rotating transmission part of the transmission, e.g. a sun gear or at least one planetary gear of an epicyclic transmission, is acquired periodically by means of the at least one electronic sensor apparatus at a measuring point at at least one specified triggering time (and therefore in a phase-synchronous fashion),
the measured values or measured value profiles for the measuring point which are acquired at successive triggering times are summed, and the sum of the measured values or a summed measured value profile is stored,
a counter reading stored in a counter memory is increased electronically by 1 at each triggering time for the rotating transmission part,
ensemble averaging is carried out automatically for the acquired measured values or measured value profiles in that after each increase in the counter reading the sum of the measured values or each measured value of the summed value profile is divided by the counter reading in order in this way to determine an ensemble average which tends toward a finite value for the measured value components which correlate at the triggering time and which tends toward zero for the non-correlated measured value components, and
the ensemble average is compared with at least one reference value or reference profile by means of an electronic evaluation logic in order to output a message about any damage, excessive wear and/or imbalance which has occurred within the transmission in the event of a deviation of the ensemble average from the at least one reference value or reference profile beyond at least one threshold value (in the case of an epicyclic transmission particularly an indication of a non-uniform load distribution on the planets or non-uniform load distribution on the planets during rotation within the epicyclic transmission).

Non-correlated measured value components or signal components are eliminated over time by means of ensemble averaging with phase-precise triggering, preferably by triggering via the transmission shafts of the transmission. This is done e.g. by virtue of the fact that the same tooth combination is always recorded by measuring and added to the previous measurements of the same tooth combination and divided by the number of measurements. The adding occurs here in a phase-synchronous fashion so that correlation with the observed detail can be established.

Non-correlated measured value components tend toward infinitely toward zero with the number of triggering times which are decisive for the periodic data acquisition operations, while correlated measured value components tend toward infinitely toward a fixed finite value. If, for example, a statement about the eccentricity of a transmission gear of the transmission is to be made here, the correlation must lie at a triggering time which repeats after a revolution. In this context, with respect to the selection of the triggering time it is firstly basically open whether e.g. during the observation of the sun gear in an epicyclic transmission the planetary gears are repeatedly at the same position in order to avoid variances as a result of the planetary gears in the evaluation, or different positions of planetary gears are always presumed for the successive triggering times so that the planetary gears average out. The same consideration applies to the observation of eccentricity of the planetary gears. The uniformity of the transmission of force by the planetary gears of the epicyclic transmission can also be of interest. Here, the effects of any eccentricities of the planetary gears and of a deviating force transmission of a planetary gear, e.g. as a result of a changed shaft of the planet axis, are possibly added together.

In one embodiment there is provision that while the transmission is operating
at least one measured value or one measured value profile is acquired periodically at the measuring point by means of the at least one electronic sensor apparatus at the least one triggering time at which at least two rotating transmission parts of the transmission are at a specific phase angle with respect to one another,
the time at which at least one specific observed tooth of a rotating transmission part in the form of a gear wheel passes the measuring point is also acquired electronically, and the number of the passes is stored in the counter memory in that the counter reading stored in the counter memory is increased by 1 whenever the tooth passes, and
ensemble averaging is carried out automatically for the acquired measured values or measured value profiles in that after each increase in the counter reading the sum of the measured values or each measured value of the summed measured value profile is divided by the counter reading representing the number of passes, in order in this way to determine the ensemble average for the measuring point and the observed tooth.

The acquired measured value or the acquired measured value profile, respectively, represents here the force profile or position profile at the tooth contact (divided into a rolling phase and a sliding phase). Therefore, the position of the force input onto the tooth edges, which is reflected in the measurement of the acquired measured values, varies with the running of the tooth edges with respect to one another. The force input starts at a narrow (axial) side of the tooth, and this zone widens out to the full tooth width. Then, the zone of the force input becomes smaller again and in the process is reduced on the opposite (axial) side of the tooth. Force-induced deformations can be measured here as long as, e.g. on a piezo-element of the sensor apparatus, as long as a sensor of the sensor apparatus is mounted on the load path of the “stress lines”. In this context, it would, for example, also be advantageous to introduce sensors or sensor apparatuses, respectively, on observed teeth, which sensors or sensor apparatuses are able to measure the acting force with sufficient resolution over the entire length of a tooth engagement.

For example, a deformation and/or solid-borne sound can be measured at the measuring point by means of the at least one sensor apparatus. The summed measured values or measured value profiles of the associated measurement signals permit a reliable statement about different faults here by virtue of the ensemble averaging which is provided. For example, they can be used to detect wear of the teeth, a fracture or crack in a tooth, a fracture in the ring gear, one-sided running of the planetary gears, a static and/or dynamic axial offset, uneven running in the bearings of the planetary gears, uneven running in the output shaft (and therefore e.g. of a propeller axis when the (epicyclic) transmission is used in an aircraft engine) or uneven running in the input shaft (and therefore e.g. of a turbine axle when the (epicyclic) transmission is used in an aircraft engine), since the corresponding faults or wear phenomena result in different deviations in the ensemble average in comparison with the reference value or reference profile—which is, if appropriate, also ensemble-averaged. Accordingly, by means of the evaluation logic it is basically possible to detect, on the basis of the ensemble average,
damage and/or wear on a tooth edge of a tooth of a planetary gear of an epicyclic transmission and/or
damage and/or wear on a tooth edge of a tooth of a sun gear of an epicyclic transmission and/or
an imbalance of a planetary shaft on which a planetary gear of an epicyclic transmission is rotatably mounted and/or
an imbalance of a sun shaft which is connected in a rotationally fixed fashion to a sun gear of an epicyclic transmission and/or
unequal loading of various planetary gears of an epicyclic transmission.

The triggering time is selected, for example, on the basis of a phase angle of at least two rotating transmission parts of the transmission with respect to one another.

The triggering time serves therefore e.g. as a reference for a change at the observed tooth. Basically, the triggering time can be specified by the phase angle of an output shaft and of an input shaft of the transmission. The phase angle and therefore the triggering time or the triggering times are specified here, for example, by the shaft or the gearwheel on which an observed tooth is provided.

In one embodiment variant, for example sensor apparatuses, which are able to measure the force input and the solid-borne sound by means of a deformation at the respective measuring point, are mounted, for example, at measuring points on a fixed ring gear of an epicyclic transmission. The pairings of teeth of the different gear wheels, in particular of the teeth of the ring gear and the teeth of a planetary gear repeat periodically at certain time intervals. Taking this as a basis, there is therefore provision in one variant that a number is assigned to each individual tooth on each planetary gear. Whenever the tooth assigned unambiguously to this number appears again at the measuring point, the acquired measured value or measured value profile is summed in a memory which is assigned to the number or to the tooth, respectively. For the ensemble averaging, the sum is then divided by the number of measurements which is acquired at a counter reading. The signals or signal components which are correlated at a triggering time are amplified. The signals or signal components which do not correlate at a triggering time tend toward zero for the ensemble average.

Depending on whether e.g.
damage and/or wear on a tooth edge of a tooth of a planetary gear of an epicyclic transmission and/or
damage and/or wear on a tooth edge of a tooth of a sun gear of an epicyclic transmission and/or
an imbalance of a planetary shaft on which a planetary gear of an epicyclic transmission is rotatably mounted and/or
an imbalance of a sun shaft which is connected in a rotationally fixed fashion to a sun gear, and/or
unequal loading of various planetary gears of an epicyclic transmission is detected, the ensemble average can be calculated differently. Therefore, particularly the ensemble average which is used as the basis for the detection of damage on a tooth edge can be differentiated from that ensemble average which is used as the basis for the detection of an imbalance of the sun gear.

A challenge with the proposed method is e.g. the precise acquisition of a phase angle in order to be able to determine precisely the times of the summing (triggering times). For example, a triggering time is specified by means of a phase-determining sensor system which has at least one additional sensor apparatus.

In one variant, the phase-determining sensor system comprises at least one sensor means, as part of the sensor apparatus, which sensor means is assigned to a shaft or a gearwheel of the transmission. This includes, in particular, a development in which in each case at least one sensor means is provided for each shaft or each gearwheel of an epicyclic transmission.

In this context, a triggering time can be defined for the observed tooth at a position of rest of an epicyclic transmission, at which position the observed tooth bears, at the measuring point, against another tooth of the transmission part which is provided with at least one sensor apparatus. In this variant, it is therefore defined by means of the phase-determining sensor system, that, for example, a signal which can be acquired by means of the phase-determining sensor system at the current position of rest is decisive for the phase angle and therefore for the triggering time, and therefore the summing is to take place at each renewed (periodic) occurrence of this signal while the epicyclic transmission is operating.

Particularly for this purpose, the phase-determining sensor system can contain at least one marking means, which can be detected by sensors, on each shaft or each gearwheel and at least one reading sensor means. “Reading” of the phase information of the shaft or of the gearwheel using the marking means and the sensor means can be carried out here basically using different technologies, e.g. magnetically, optically, capacitively and/or inductively.

In one embodiment variant there is provision that after a comparison of the ensemble average with the at least one reference value or reference profile it is checked whether the counter reading exceeds a stored forgetting factor, and in the event of the counter reading being higher than the forgetting factor, the sum of the measured values or the summed measured value profile, along with the counter reading, are set to zero before the next triggering time. After the comparison of the ensemble average with the at least one reference value or reference profile in order to evaluate whether there is damage, excessive wear and/or an imbalance within the transmission, if appropriate, firstly the sum of the measured values or the summed measured value profile and, secondly, the associated counter reading are therefore set to zero. With this resetting of the parameters which are decisive for the ensemble averaging it is possible to avoid a situation in which any newly occurring fault owing to a large number of measured values at preceding triggering times at which a fault was not present is initially not manifest to a significant degree and is only detected after a multiplicity of further measuring cycles. In this context there can also be provision that summed measured values or measured value profiles are stored in different memories and different forgetting factors are stored for these different memories depending on the faults to be detected. Therefore, for example a first forgetting factor can be stored for the ensemble averaging for the detection of a tooth fault and a second forgetting factor, which is different from the first, can be stored for the ensemble averaging for the detection of an imbalance. The forgetting factor for the detection of an imbalance is usually selected to have a larger value here, so that resetting to zero only occurs after a multiplicity of measuring cycles, since an imbalance which has occurred can be determined with a higher level of certainty on the basis of a relatively long measuring series and comparison with at least one reference value or at least one reference profile than on the basis of a relatively short measuring series.

In one embodiment variant there is provision that the sum of the measured values or the summed measured value profile is always determined by means of a specified limited number of acquired measured values or acquired measured value profiles, respectively. In this variant, relatively old values are therefore not deleted after the summing but instead filled with new values, and the oldest values are overwritten by “moving them through” (so-called “moving average”). The sum used for the ensemble averaging is then always formed over a current data set which contains a specific number of last-acquired measured values or measured value profiles.

Basically, the at least one reference value or the at least one reference profile may also have been determined by ensemble averaging for the measuring point by means of the electronic sensor apparatus at the triggering time, e.g. for a specified reference time period of the (epicyclic) transmission. A reference time period is understood here to be e.g. the time period in which the (epicyclic) transmission has been operated until it is “run in”. The reference time period therefore includes particularly a so-called run-in time of the (epicyclic) transmission. Consequently, after the mounting of the (epicyclic) transmission at least one ensemble-averaged reference value or at least one ensemble-averaged reference value profile is acquired over a run-in time and stored. Then, while the (epicyclic) transmission is operating, it is possible to check in an automated fashion with respect to this ensemble-averaged reference value or reference value profile and a delivery state defined thereby, whether damage, excessive wear and/or an imbalance have occurred.

Alternatively or additionally, the at least one reference value or at least one reference profile can (additionally) be based on a service life model for the (epicyclic) transmission. For example a tolerated wear level over the service life of the (epicyclic) transmission is then taken into account in the reference value or reference profile. Accordingly, e.g. a reference value which is used for the evaluation of any damage, excessive wear and/or imbalance which has occurred within the (epicyclic) transmission and which is acquired from a stored reference curve varies over the service life of the (epicyclic) transmission.

As has already been mentioned, in one embodiment variant a plurality of electronic sensor apparatuses is provided at different measuring points on the same transmission part of the transmission, e.g. on the ring gear of an epicyclic transmission, at each of which at least one measured value or one measured value profile is repeatedly acquired at one or more triggering times. In this context, the decisive phase angles for the different measuring points are then usually different at a plurality of triggering times. It is therefore possible to detect, for example electronically, for the different measuring points the time at which at least one specific tooth of a plurality of observed teeth of different rotating gear wheels passes the assigned measuring point. The number of passes is stored in an associated counter memory for each observed tooth, in that an encounter reading, stored in the counter memory, for this tooth is increased by 1 whenever the respective tooth passes the associated measuring points. In this context, ensemble averaging is then carried out automatically for the acquired measured values or measured value profiles in that after each increase in the counter reading the sum of the measured values or each measured value of the summed measured value profile is divided by the number of passes of this tooth, in order in this way to determine the ensemble average for the respective measuring point on the basis of the associated tooth.

For example, for this, an electronic sensor apparatus is provided on the fixed ring gear, for each planetary gear, meshing with the ring gear, of an epicyclic transmission. However, this is not compulsory. Sufficiently informative measurement data can already be acquired by means of a sensor apparatus on the ring gear. However, when there are a plurality of sensor apparatuses arranged distributed over the circumference of the ring gear it is also possible to compare the behaviors of the ring gear in individual sections with one another and therefore check them electronically.

In one variant, a first measured value or a first measured value profile can be acquired for all the different measuring points on the transmission, in particular an epicyclic transmission, wherein an average value or average value profile is then formed from the first measured values or first measured value profiles acquired for the different measuring points, in order to average influence of the respectively observed teeth. However, particularly in the case of a new epicyclic transmission (without wear phenomena), in a delivery state a reference value or reference profile can nevertheless also be formed only via the instrumentation.

In one variant, measured values or measured value profiles can be acquired for different tooth segments of the same observed tooth at a measuring point by means of the at least one electronic sensor apparatus. In this context, in order to carry out ensemble averaging for different tooth segments, the counter reading for the tooth comprising the tooth segments is respectively used. As a result, finer resolution can consequently be obtained by virtue of the fact that the segment of the tooth is divided into a large number of small segments. The ensemble averaging is then carried out over these small segments of a tooth.

As already mentioned at the beginning, one embodiment variant provides that the determination of damage, wear and/or imbalance takes place while a transmission of an engine, particularly of a gas turbine engine, is operating.

A further aspect of the invention is the provision of a device for determining damage, wear and/or imbalance in a transmission configured as a gear transmission, particularly an epicyclic transmission, by means of at least one electronic sensor apparatus of the device.

There is provision here that
at least one measured value or measured value profile for a rotating transmission part of the transmission can be acquired periodically by means of the at least one electronic sensor apparatus at a measuring point on a transmission part of the transmission at at least one specified triggering time, while the transmission is operating,
the device has an evaluation logic, by means of which measured values or measured value profiles for the measuring point which are acquired at successive triggering times are summed, and the sum of the measured values or a summed measured value profile is stored by means of a memory apparatus of the device,
the memory apparatus is configured and provided to store a counter reading, which is increased by 1 at a triggering time for the rotating transmission part, in a counter memory,
ensemble averaging can be carried out automatically for the acquired measured values or measured value profiles by means of the evaluation logic in that after each increase in the counter reading the sum of the measured values or each measured value of the summed measured value profile division is carried out by means of the counter reading in order in this way to determine an ensemble average for the measuring point which tends toward a finite value for the measured value components which correlate at the triggering time and which tends toward zero for the non-correlated measured value components, and
the ensemble average is comparable with at least one reference value or reference profile by means of the evaluation logic in order to output a message about any damage, excessive wear and/or imbalance which has occurred within the transmission in the event of a deviation of the ensemble average from the at least one reference value or reference profile beyond at least one threshold value (in the case of an epicyclic transmission particularly an indication of a non-uniform load distribution on the planets or non-uniform load distribution on the planets during rotation within the epicyclic transmission).

One embodiment variant of a device according to the invention can be configured and provided in particular to carry out a method according to the invention. Accordingly, advantages and features explained above and below in conjunction with embodiment variants of a method according to the invention also apply to embodiment variants of a device according to the invention, and vice versa.

For example, one embodiment variant provides that
at least one measured value or measured value profile for a rotating transmission part of the transmission can be acquired periodically by means of the at least one electronic sensor apparatus at the measuring point on a transmission part of the transmission, at which at least two rotating transmission parts of the epicyclic transmission are at a specific phase angle with respect to one another, at at least one specified triggering time while the transmission is operating, and
the time at which at least one specific observed tooth of a rotating transmission part in the form of a gearwheel passes the measuring point can also be electronically detected by means of the device, wherein the memory apparatus is configured and provided to store the number of the passes as stored in the counter memory in that the counter reading stored in the counter memory is increased by 1 whenever the tooth passes.

The appended figures illustrate exemplary possible design variants of the proposed solution.

In the figures:

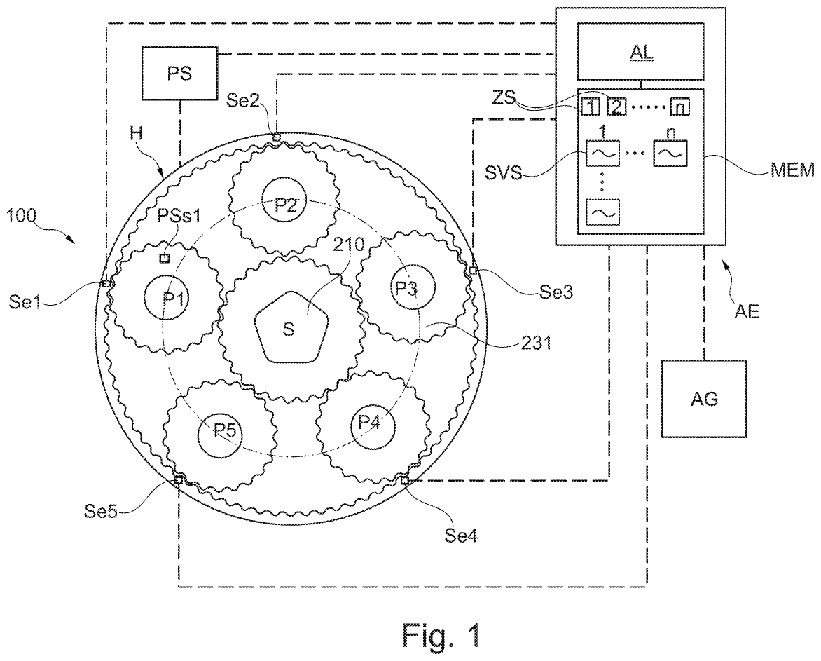

FIG. 1 shows an embodiment variant of a device according to the invention with an epicyclic transmission in a sectional illustration;

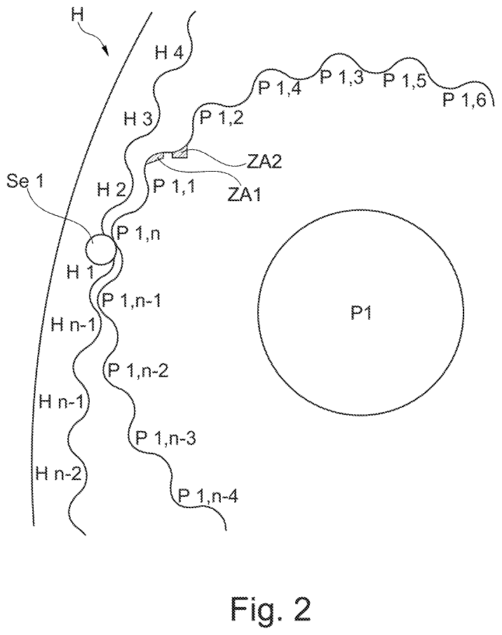

FIG. 2 shows, on an enlarged scale, a detail of an internally toothed ring gear of the epicyclic transmission in FIG. 1 with a partially illustrated planetary gear which meshes with the ring gear;

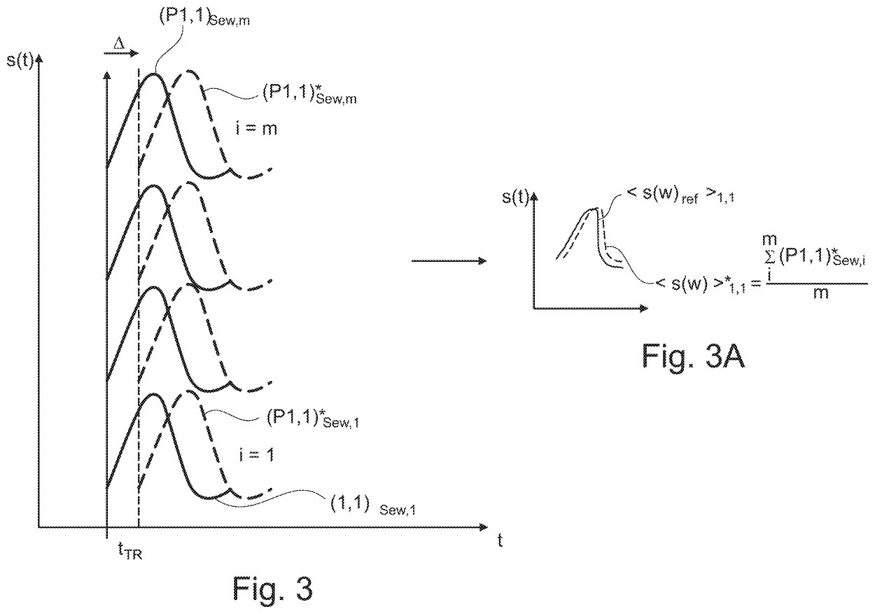

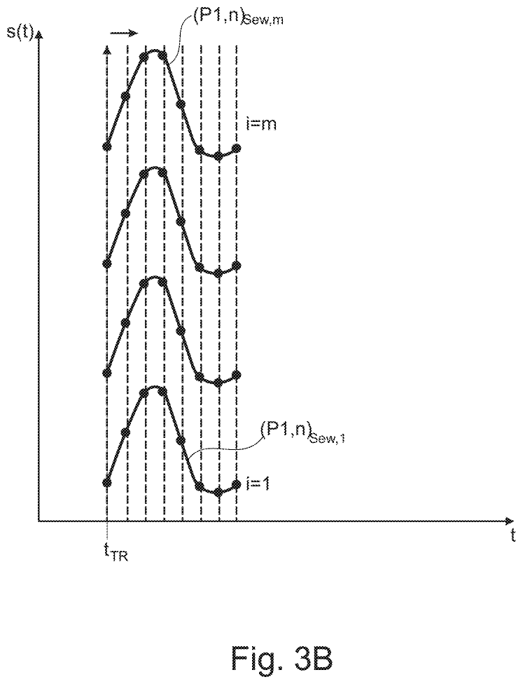

FIG. 3 shows a diagram illustrating different summed signal profiles recorded at periodically recurring triggering times;

FIG. 3A shows a schematic diagram of the comparison of an ensemble average, acquired from the signal profiles in FIG. 3, with a reference signal profile;

FIG. 3B shows a diagram illustrating summed signal profiles with a plurality of sampling points;

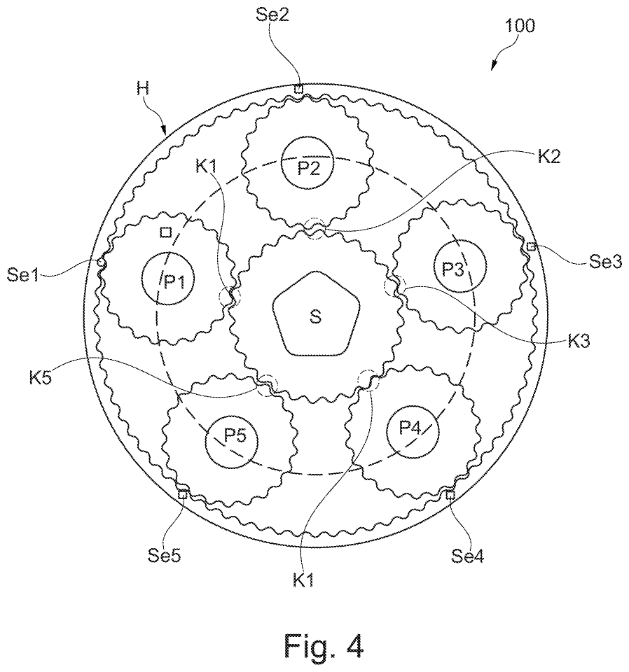

FIG. 4 shows the epicyclic transmission with an illustration of different contact regions between the planetary gears and a central sun gear of the epicyclic transmission;

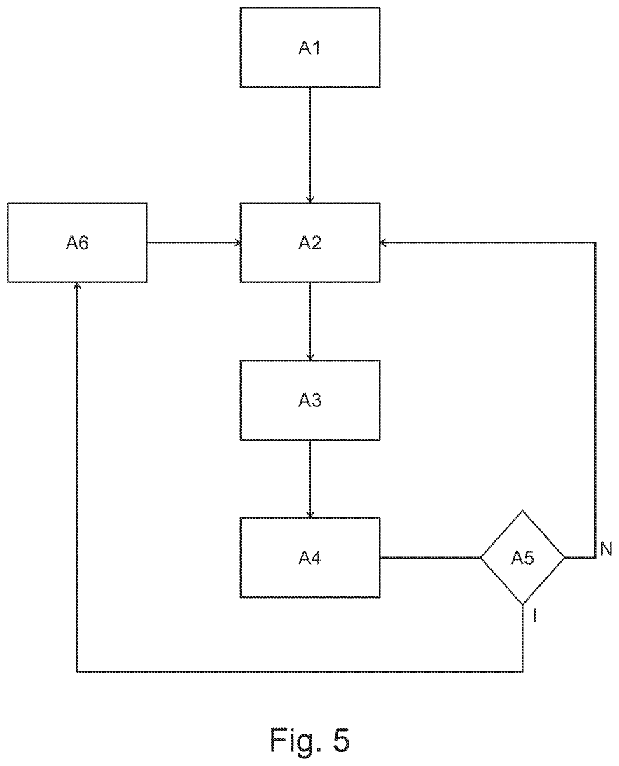

FIG. 5 shows schematically an embodiment variant of a method according to the invention;

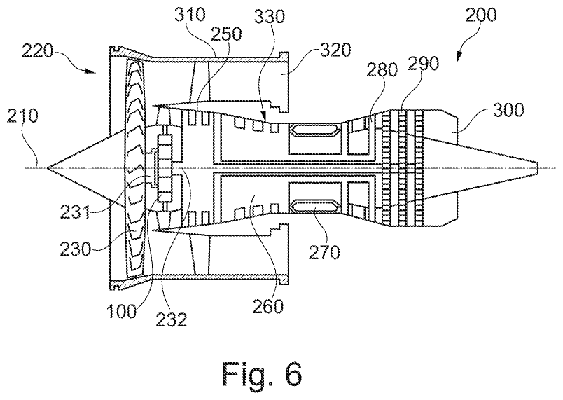

FIG. 6 shows a gas turbine engine in a sectional side view, in which a device according to the invention and a method according to the invention are used.

FIG. 6 shows a side view of a gas turbine engine 200 in which the individual components are arranged one behind the other along a rotational axis or central axis 210. The gas turbine engine 200 in FIG. 6 is embodied here as a so called geared turbofan engine, i.e. as a turbofan engine with a reduction gear unit for driving a fan 230 arranged at an inlet or intake 220.

This fan 230 feeds air via the inlet 220 into the gas turbine engine 200 and in the process, firstly, in a manner known per se into a bypass duct 230 of a fan casing 310 and, secondly, to a core engine 330. Within the core engine 330, the sucked-in air is compressed by means of a low-pressure compressor 250 and a high-pressure compressor 260 arranged downstream thereof and fed to a combustion chamber 270. A turbine stage of the gas turbine engine 200 having a high-pressure turbine 280 and a low-pressure turbine 290 is acted on by means of the combustion taking place in the combustion chamber 270 by means of the supplied air, before the outflowing exhaust gases are conducted outward at an outlet 300 of the gas turbine engine 200.

Firstly, the compressor stage with the low-pressure compressor 250 and the high-pressure compressor 260 and, secondly, the fan 230 are driven by means of the turbine stage with a high-pressure turbine 280 and low-pressure turbine 290, the fan in order to make available the greater part of the thrust by means of the air fed into the bypass duct 230. A turbine shaft which is driven by the turbine stage, usually the low-pressure turbine 290, is used to drive the fan 230 here. An epicyclic transmission 100 is provided in this context to reduce the rotational speed of the turbine shaft for driving the fan 230. In this epicyclic transmission 100, the shaft which is connected to the turbine stage is provided as an input shaft 232, on which a sun gear S of the epicyclic transmission 100 is arranged in a rotationally fixed fashion. A rotation of the input shaft 232 is converted, by means of the epicyclic transmission 100, into a rotation with a reduced rotational speed of an output shaft 231 of the epicyclic transmission 100, which output shaft 231 drives the fan 230. This output shaft 231 is formed here by the spider shaft of the epicyclic transmission 100. The output shaft 231 is correspondingly connected to the axles of the planetary gears P1 to P5, rotating about the sun gear S, of the epicyclic transmission 100 and consequently to a planetary carrier of the epicyclic transmission 100. The sun gear S and the planetary gears P1 to P5 are arranged within an internally toothed ring gear H of the epicyclic transmission 100 on which the planetary gears P1 to P5 roll, while being driven by the sun gear S (cf. also FIG. 1 in this context).

Since any fault, particularly damage to a fixed or rotating gearwheel, wear and/or imbalances which occur while the epicyclic transmission 100 is operating, can have fatal consequences for the functional reliability and the functional capability of the gas turbine engine 200, monitoring of the epicyclic transmission 100 by sensor is particularly desirable in this respect. However, in this context there is basically the difficulty that a fault cannot be readily detected by measuring technology, in particular by means of sensors mounted on the outside. The solution according to the invention is intended to remedy this.

One possible embodiment variant is illustrated in more detail here with reference to FIG. 1. The epicyclic transmission 100 shown in FIG. 1 has a plurality of sensor apparatuses, in the present case five, Se1 to Se5, on the fixed ring gear H. These sensor apparatuses Se1 to Se5 are coupled to an electronic evaluation apparatus AE. This evaluation apparatus AE has an evaluation logic AL for acquiring and evaluating measurement signals which are made available to the sensor apparatuses Se1 to Se5. In addition, a memory MEM is part of the evaluation apparatus AE. This memory MEM comprises, firstly, a signal profile memory SVS for storing (summed) measurement signals as well as a plurality of counter memories ZS for storing counter readings. The evaluation logic AL of the evaluation apparatus AE is configured to carry out ensemble averaging using measurement signals and counter readings stored in the memory MEM. The ensemble averages determined here can be compared with reference values or reference profiles stored in the evaluation apparatus AE. On the basis of deviations of the respective ensemble average from one or more reference values or reference profiles it is then possible to determine automatically whether damage, excessive wear and/or an imbalance or non-uniform load distribution on the planetary gears P1 to P5 or non-uniform load distribution on the planetary gears P1 to P5 during the rotation within the epicyclic transmission 100 has occurred. In such a case, an alarm signal can be output via an alarm AG which is coupled to the evaluation apparatus AE or integrated therein, or a fault flag which can be read out can be set.

A phase-determining sensor system PS is provided, since for the proposed ensemble averaging of measurement signals which are acquired at the sensor apparatuses Se1 to Se5 it is necessary to ensure that the respective measurement signals are acquired in a phase-synchronous fashion at successive triggering times. By means of this phase-determining sensor system PS, the respective triggering times at which measurement signals which are acquired by the sensor apparatuses Se1 to Se5 have to be summed in the signal profile memory SVS, and an associated counter reading in the respective counter memory ZS has to be increased by 1.

Part of the phase-determining sensor system PS is, for example, a sensor means PSs1 which is arranged on one of the planetary gears P1 to P5, in order to be able to acquire a phase angle of a planetary gear P1. For example, this can be a detectable marking which can be read out by a sensor arranged on the ring gear H. However, sensor means PSs1 which are provided for measuring the planetary phase on a planetary gear P1 can also be, for example, a small magnet which can be detected by means of a coil arranged on the ring gear H. Owing to the epicyclic paths of the planetary gears P1 to P5 which migrate around the sun gear S while the epicyclic transmission 100 is operating, such a coil is then to be provided at the level of the overlap of the epicyclic paths, in order to reliably acquire the phase angle of the planetary gears P1 to P5. However, the phase angle can basically also be determined on the basis of other technologies, e.g. optically, capacitively and/or inductively.

Here, in each case a measurement of the forces acting at the tooth contact is performed at the sensor apparatuses Se1 to Se5 which are arranged on the fixed ring gear H. For this, deformation can be measured by means of the respective sensor apparatuses Se1 to Se5 on the ring gear H. In addition to a force, it can also be possible to measure the solid-borne sound by means of the respective sensor apparatus Se1 to Se5. For this, each sensor apparatus Se1 to Se5 is equipped, for example, with a piezo-element. A further measuring method for the measurement on the fixed ring gear H is e.g. inverse magnetostriction. Inverse magnetostriction provides the advantage that the force-dependent deformation in the material and therefore also the force profile in the center of the teeth can be measured directly. This can be achieved by coils or Hall sensors mounted outside the gear wheels. As a result, deformations are not only detectable where sensor apparatuses can be mounted without problems.

In order to be able to obtain definitive information (a) about any damage to a tooth, particularly a tooth of the planetary gears P1 to P5, (b) about excessive wear and/or (c) about imbalance which has occurred at one or a plurality of the planetary gears P1 to P5 or the sun gear S, by means of the sensor apparatuses Se1 to Se5 which are provided on the fixed ring gear H and with which a deformation and/or solid-borne sound can be measured, a correlation is established here with the detail which is to be respectively observed, by means of phase-synchronous, periodic addition of measurement signals. In this context, the proposed solution proceeds from the basic concept that by means of ensemble averaging with phase-precise triggering by the transmission shafts of the epicyclic transmission 100, here the input shaft 232 with the sun gear S and the output shaft 231 of the planetary gears P1 to P5, non-correlated signal components or measured value components are eliminated over time.

In the illustrated exemplary embodiment of the epicyclic transmission 100 in FIG. 1, for example the same tooth combinations are always measured, added in each case to previous measurements of the same tooth combinations and divided by the number of measurements. The pairings of teeth of the ring gear H and of the individual planetary gears P1 to P5 therefore repeat at relatively long time intervals. As is illustrated in FIG. 2 on an enlarged scale, a (tooth) number P1.1 . . . P1.n is assigned for example to each individual tooth of a planetary gear P1. Whenever the correspondingly numbered tooth of the planetary gear P1 is moved past the sensor apparatus Se1 of the ring gear H again, the respective measurement signal which can be acquired at the sensor apparatus Se1 is acquired in the signal profile memory SVS of the evaluation unit AE and summed. At the same time, a counter reading for the respective tooth number P1.1 . . . P1.n is summed and therefore a counter reading for the respective tooth is increased by 1 in the counter memory ZS of the evaluation unit AE. Each tooth, which is to be observed, of the planetary gear P1 consequently has a corresponding counter reading. In order to form an ensemble average for the respective observed tooth P1.1 . . . P1.n, the summed measurement signal for each observed tooth P1.1 . . . P1.n is divided by the number of measurements which are stored in the counter memory ZS as a counter reading, at the triggering times tTR specified by means of the phase angle. The ensemble average is therefore acquired in a phase-precise fashion, synchronised, for example, with the axle angle of the input shaft 232 of the sun gear S, the output shaft 231 of the planetary gears P1 to P5 and rotation of the planetary gears P1 to P5.

In the approach outlined above, non-correlated signal components and therefore measured value components of the measurement signals which are recorded in a phase-synchronous fashion (with their amplitude) tend toward 0 if the number of measurements rises, particularly tends toward infinite. Correlating signal components and measured value components amplify one another with respect to this. From the calculated ensemble averages it is then possible not only to obtain definitive information about given correlations but also to detect—through comparison with a reference value or reference profile—whether a change, and therefore possibly a fault has occurred in comparison with a delivery state of the epicyclic transmission 100. Different faults can be detected and assigned here to a specific fault type particularly in accordance with the triggering time and the observed detail by changing the calculated ensemble average with respect to a reference value or reference profile. These include, for example:
damage and/or wear on a tooth edge of a tooth of a planetary gear P1 to P5 of the epicyclic transmission 100 and/or
damage and/or wear on a tooth edge of a tooth of a sun gear S of the epicyclic transmission 100 and/or
an imbalance of a planetary shaft on which a planetary gear P1-P5 of the epicyclic transmission 100 is rotatably mounted and/or
an imbalance of a sun shaft or input shaft 232 which is connected in a rotationally fixed fashion to a sun gear S of the epicyclic transmission 100 and/or
unequal loading of different planetary gears P1 to P5 of the epicyclic transmission 100 and/or
unequal loading of the planetary gears P1 to P5 during the rotation in the epicyclic transmission 100 (limited to where the outer ring gear H1 can be observed).

As is illustrated by way of example for a tooth P1,1 of the planetary gear P1 in FIG. 2, finer resolution of any damage on a tooth can also be obtained by dividing a tooth and particularly a respective tooth edge into a plurality of (at least two) tooth segments ZA1 and ZA2. Here, ensemble averaging is then carried out over the individual tooth segments ZA1 and ZA2, wherein measurement signals are then summed in a phase-precise fashion for each tooth segment ZA1 or ZA2 and in each case an ensemble average is formed. In this context, each tooth segment ZA1 or ZA2 has an assigned memory in the signal profile memory SVS, in which something is carried out periodically in a phase-precise fashion by means of the repetition rate of the teeth at the measuring point of the respective sensor apparatus Se1 to Se5. In order then to form a tooth-segment-related ensemble average, the respective measured value or measured value profile which is summed on the basis of the acquired measurement signals is divided by the number of measurements corresponding to the counter reading stored in the counter memory ZS.

In addition in FIG. 2, the individual teeth of the ring gear H are also consecutively numbered from H1 to Hn−1. In this context, it is additionally possible, by means of the sensor apparatuses Se1 to Se5 to perform tooth-related damage detection by pairing a specific tooth of the ring gear H (e.g. tooth H1) on which a sensor apparatus Se1 to Se5 is arranged, with the individual teeth P1.1 . . . P1.n−1 of a planetary gear P1.

In this context, the basic approach of the proposed solution is illustrated in the diagram in FIG. 3. The diagram in FIG. 3 shows here different measurement signal profiles s(t) plotted over the time t (or the phase angle of the input shaft 232). Measurement signal profiles (P1,1)₁ to (P1,1)ₘ are acquired at a periodically recurring triggering time t_{TR}, which is specified by means of the phase angle of the gear wheels (sun gear S and planetary gears P1 to P5) and remains constant. The respective signal profile is representative here of a specific tooth pairing, here by example for a pairing of the tooth H1 on the internally toothed ring gear H and the tooth P1, 1 of the one planetary gear P1. The signal profiles (P1,1)₁ bis (P1,1)ₘ which are recorded at successive triggering times t_{TR} are added in phase-synchronous fashion here. Here, the diagram in FIG. 3 illustrates the summed signal profiles for i different measurements where i=1 . . . m. Consequently, summed signal profile

$${\sum }_{i = 1}^{m} {( P 1 , 1 )}_{i}$$

corresponds to the summed signal profile of the tooth pairing between the tooth P1,1 of the planetary gear P1 and the tooth H1 of the ring gear A at the m-th time at the triggering time t_{TR}. For an ensemble average <s(1)>_{P1,1} determined therefrom for the tooth P1,1 of the planetary gear P1 at a specific sensor apparatus, e.g. the sensor apparatus Se1, the following then applies:

$${〈 s ( 1 ) 〉}_{P 1 , 1} = \frac{{\sum }_{i = 1}^{m} {( P 1 , 1 )}_{Se 1 , i}}{m} .$$

Here, the parameter m stands for the number of measurements which have been recorded as a counter reading in the counter memory ZS. The same applies for an ensemble average <s(1)>_{P1,n} calculated for a tooth n of the planetary gear P1 with the sensor apparatus Se1 over m point in time with the control variable i:

$${〈 s ( 1 ) 〉}_{P 1 , n} = \frac{{\sum }_{i = 1}^{m} {( P 1 , n )}_{Se 1 , i}}{m} .$$

Here, the control variable i represents the repetition of the respective tooth pairing. Formulated in general terms, the following is then obtained at any of w sensor apparatuses Se1 to Sew where w=1 . . . k (in the illustrated example therefore where w=1 . . . 5) for an ensemble average for an observed tooth n for the planetary gear P1:

$${〈 s ( w ) 〉}_{P 1 , n} = \frac{{\sum }_{i = 1}^{m} {( P 1 , n )}_{Sew , i}}{m} .$$

Generally, therefore the following applies for any planetary gear Px, where x=1 . . . q, wherein in the present case of 5 planetary gears q=5:

$${〈 s ( w ) 〉}_{P x , n} = \frac{{\sum }_{i = 1}^{m} {( Px , n )}_{Sew , i}}{m} .$$

In one development, the evaluation as to whether damage, excessive wear and/or an imbalance within the epicyclic transmission 100, can furthermore occur in addition on the basis of an acquired average value which is obtained over a plurality (all) of the sensor apparatuses Se1 to Se5 arranged distributed over the circumference of the ring gear H. For this, the ensemble averages for the respective observed tooth n of the k sensor apparatuses Se1 to Sew are summed, and the sum is divided by the number k of the sensor apparatuses Se1 to Sew on the circumference of the ring gear H, in order to allow any peculiarities of the ring gear H to be eliminated and not have an influence. Such an average value is consequently calculated e.g. for the tooth n of the planetary gear P1 from:

$$\overline{{〈 s 〉}_{P 1 , n}} = \frac{{\sum }_{w = 1}^{k} {〈 s ( w ) 〉}_{P 1 , n}}{k} .$$

If, conversely, the objective is to highlight any peculiarities of the ring gear H, average values would have to be formed by means of other influences.

Since the triggering time t_{TR} remains constant as result of the phase angle, the summed measurement signal can change in the event of any mechanical fault within the epicyclic transmission 100. For example, wear on the observed tooth contact causes the profile of the measurement signal to be displaced by a deviation Δ. Signal profiles (P1,n)*_{Sew,i} which are shifted with respect to the measurement signal profiles (P1,n)_{Sew,i} which are associated with fault-free operation of the epicyclic transmission 100 are consequently then acquired and summed here. If these summed changed signal profiles are then used for the determination of a (changed) ensemble average <s(w)>*_{P1,n},

$${〈 s ( w ) 〉}_{P 1 , n}^{*} = \frac{{\sum }_{i = 1}^{m} {( P 1 , n )}_{Sew , i}^{*}}{m} .$$

a deviation from a reference value or reference profile can be detected by means of the evaluation logic AL. This reference value or reference profile has, for example, also been acquired as an ensemble average <s(w)_{ref}>_{P1,n} composed of acquired measurement signals for the epicyclic transmission 100 in a delivery state (or from an average value <̅S̅_̅{̅r̅e̅f̅}̅>̅_̅{̅P̅1̅,̅n̅}̅ determined here by all sensor apparatuses. For example, (particularly) the measurement signal profiles (P1,1)_{Se1,1} to (P1,1)_{Se1,m} at the sensor apparatus Se1 for the tooth 1 of the planetary gear P1 are used for this, which measurement profiles have been acquired for a reference number m_{Ref} in a run-in time of the epicyclic transmission 100. The following then applies here (m=m_{ref}):

$${〈 {s ( 1 )}_{ref} 〉}_{P 1 , 1} = \frac{{\sum }_{i = 1}^{m} {( P 1 , 1 )}_{Se 1 , i}}{{m}_{ref}} .$$

Alternatively, the reference value or reference profile can, of course, also have been acquired from the instrumentation in the delivery state of the epicyclic transmission 100. All this is decisive for is that signal components or measured value components, which do not correlate over the ensemble averaging, for a rising number of measurements tend toward 0, while correlating signal components or measured value components tend toward a finite value. In this way, during the phase-precise triggering of the acquisition of the measured values, any damage, excessive wear and/or imbalances within the epicyclic transmission 100 can be detected comparatively easily from the ensemble-averaged measured values or measured value profiles, wherein for this deformations on the teeth of the ring gear H and, if appropriate, additionally the solid-borne sound, are merely measured by means of the sensor apparatuses Se1 to Se5 on the fixed ring gear H.

Therefore, for example the force input at the measuring point defined by means of the respective sensor apparatus Se1 to Se5 changes with the frequency of the sun gear S or of the input shaft 232, respectively. This then makes it possible to infer an absence of smooth running of the input shaft 232. If the measured force input changes, in contrast with the frequency of the output shaft 231, this then makes it possible to infer an absence of smooth running of the planetary shafts, which support the planetary gears P1 to P5 in a rotatable fashion, of the planetary carrier which is connected to the output shaft 231. Unequal loading when passing the individual planetary gears P1 to P5 in turn makes it possible to infer that there is an offset of a planetary gear shaft or wear on a tooth of a planetary gear P1 to P5. Likewise, in the case of wear on the tooth edges a phase angle shifts when tooth contact occurs.

If, as already mentioned above, piezo-elements are used on the sensor apparatuses Se1 to Se5, they can also measure solid-borne sound. This solid-borne sound can in turn also be used for diagnostics. Moreover, it is to be noted that at the frictionally locking contact between two teeth (driving and driven gearwheel) there is a frictional moment between the teeth. At this moment, slip-stick movements occur which are transmitted as solid-borne sound into the tooth geometry. A piezo-element on the stationary ring gear H on the tooth base of a tooth of the ring gear H can then sense this solid-borne sound and therefore be used to detect slip-stick effects by sensor.

The additional possibility of receiving more detailed information about the rolling at the tooth contact is also illustrated with FIG. 3B. Here, chronologically subsequent sampling points are provided in addition to the adding and ensemble averaging at the triggering time tTR. At the chronologically subsequent sampling points, a sum of individual measured values of the acquired signal profiles (as a sum of the individual points on the perpendicularly running lines, illustrated by dashes, in FIG. 3B) and the respectively summed measured value are divided by the number of measurements which is stored in the counter memory ZS. In this way, the profile of the individual tooth contacts can be analyzed at the sampling times by means of ensemble-averaged measured values.

In addition, gearwheel pairings between a planetary gear P1 to P5 and the sun gear S can be evaluated on the basis of the proposed solution, specifically on the basis of the effect on the observed tooth ring gear H, for example H1, on which a sensor apparatus Se1, Se2, Se3, Se4 or Se5 is provided. Here, the tooth of the sun gear S is evaluated in the interaction with the average value of the interaction of all the teeth of all the planets P1 to P5 in the force effect on the tooth on the ring gear H with the sensor apparatus Se1 to Se5. An imbalance which occurs in the sun gear S can be detected here with the sensor apparatuses Se1 to Se5.

In this context, reference will be made by way of example to FIG. 4 in which the epicyclic transmission 100 is illustrated with contact regions K1 to K5. In each case the force transmission from the driving sun gear S to a planetary gear P1 to P5 takes place at the illustrated contact regions K1 to K5. In the respective contact region K1 to K5 any eccentricity of the sun gear S as well as erosion on the tooth edges of the sun gear S are also transmitted to the planetary gears P1 to P5 which mesh therewith. This acts in turn on the measurable force input at the measuring points on the fixed ring gear H defined by the sensor apparatus Se1 to Se5. Therefore, definitive information can also be acquired about the gearwheel contacts between the sun gear S and the planetary gears P1 to P5 and also with respect to any imbalance of the sun gear S or of the planetary gears P1 to P5 by means of the ensemble-averaged measured values or measured value profiles which are acquired by the sensor apparatuses Se1 to Se5 on the fixed ring gear H.

It is to be noted that trigger signals for specifying a triggering time tTR for the ensemble averaging to be carried out can basically (also) come from precise phase measurements of the shafts. Triggering for the measurements within a tooth contact can also occur at the start of the force flux (FIG. 3B).

The flow diagram in FIG. 5 also illustrates by way of example a possible embodiment variant of the method according to the invention. In this context, in a first method step A1, the phase relationship of the gearwheels of the epicyclic transmission 100 and therefore the triggering time tTR are determined by means of the phase-determining sensor system PS. Furthermore, in the method step A1 it is also possible to form an average value over the measurements of the sensor apparatuses Se1 to Se5 for the selection of the possible tooth combinations, in order to average the influence of the teeth of the ring gear H on which deformation and solid-borne sound are measured while the epicyclic transmission 100 is operating.

In a subsequent method step A2, the measurement signals or measured values or measured value profiles including the summing in the signal profile memory SVS then occur at the triggering times. At the same time, the respective counter reading (of possibly a plurality of tooth-specific and/or fault-specific counter readings) is increased in the counter memory ZS in order to store the number of measurements which have been performed.

In a subsequent method step A3, the ensemble averaging takes place for the respective tooth or the respective gearwheel pairing, and an evaluation as to whether under certain circumstances it is possible to detect a deviation—in comparison with the reference value or reference profile—is carried out on the basis of the ensemble average which is determined here.

Here, an indication of a specific type of fault, for example an indication in the form of an alarm message about possible damage to one or more teeth and/or about any imbalance within the epicyclic transmission 100 is then subsequently output automatically on the basis of stored categories, in accordance with the selected triggering time tTR and therefore the observed detail and/or in accordance with the type and degree of deviation. The above comparison with the reference value or reference profile and the outputting of a possible indication take place here in a method step A4 in the flow diagram in FIG. 5.

This method step A4 is followed by an interrogation in a method step A5 as to whether a current counter reading (for the detail to be observed) or a plurality of counter readings exceeds or exceed a stored forgetting factor. Therefore, depending on the fault to be detected and for any correlation with respect to an assumed phase relationship, it is appropriate to provide a specific forgetting factor in order to set the counter reading and the sum of the measured values or a summed measured value profile back to zero. For this, at least one forgetting factor (e.g. at a level of 10, 50 or 100) is provided, setting to zero occurring when said factor is exceeded. If the comparison of the (respective) counter reading with the stored forgetting factor reveals that setting to zero has to be performed, this is done in a method step A6 before a new measurement signal is acquired at the next triggering time and summing is carried out in the signal profile memory SVS.

The sum of the measured values or the summed measured value profile can e.g. also be determined over a specified limited number of acquired measured values or measured value profiles, respectively. In this variant, relatively old values are therefore not deleted after the summing but instead filled with new values, and the oldest values are overwritten by “moving them through” (so-called “moving average”). The sum used for the ensemble averaging is then always formed over a current data set which contains a specific number of last-acquired measured values or measured value profiles.

### LIST OF REFERENCE SIGNS

100 Planetary transmission/epicyclic transmission
200 Gas turbine engine
210 Rotational axis/central axis
220 Inlet/Intake
230 Fan
231 Output shaft
232 Input shaft
250 Low-pressure compressor
260 High-pressure compressor
270 Combustion chamber
280 High-pressure turbine
290 Low-pressure turbine
300 Outlet
310 Fan casing
320 Bypass duct
330 Core engine
AE Evaluation apparatus
AG Alarm
AL Evaluation logic
H Ring gear
K1-K5 Contact region
MEM Memory
m, m_{Ref} Number
P1-P5 Planetary gear
PS Phase-determining sensor system
PSs1 Sensor means/detectable marking
S Sun gear
(P1,n)_{Sew,i}, (P1,n)*_{Sew,i} Signal profile
<s(w)>_{P1,n} Ensemble average
<s(w)>_{P1,n},
<s(w)_{ref}>_{P1,n}
<̅S̅_̅{̅r̅e̅f̅}̅>̅_̅{̅P̅1̅,̅n̅}̅ Mean value
Se1-Se5 Sensor apparatus
SVS Signal profile memory
t_{TR} Triggering time
ZA1, ZA2 Tooth segment
ZS Counter memory
Δ Deviation

1. A method for determining damage, wear and/or imbalance in a transmission configured as a gear transmission, particularly an epicyclic transmission, by means of at least one electronic sensor apparatus, wherein, while the transmission is operating,
in each case at least one measured value or measured value profile ((P1,n)*_{Sew,i}) for a rotating transmission part of the transmission is acquired periodically by means of the at least one electronic sensor apparatus at a measuring point on a transmission part of the transmission at least one specified triggering time,
the measured values or measured value profiles ((P1,n)*_{Sew,i}) for the measuring point which are acquired at successive triggering times are summed, and the sum of the measured values or a summed measured value profile is stored,
a counter reading stored in a counter memory is increased electronically by 1 at each triggering time for the rotating transmission part,
ensemble averaging is carried out automatically for the acquired measured values or measured value profiles ((P1,n)*_{Sew,i}) in that after each increase in the counter reading the sum of the measured values or each measured value of the summed value profile
((P1,n)*_{Sew,i}) is divided by the counter reading in order in this way to determine an ensemble average (<s(w)>*_{P1,n}) which tends toward a finite value for the measured value components which correlate at the triggering time and which tends toward zero for the non-correlated measured value components, and
the ensemble average (<s(w)>*_{P1,n}) is compared with at least one reference value or reference profile (<s(w)_{ref}>_{P1,n}) by means of an electronic evaluation logic in order to output a message about any damage, excessive wear and/or imbalance which has occurred within the transmission in the event of a deviation of the ensemble average (<s(w)>*_{P1,n}) from the at least one reference value or reference profile (<s(w)>_{P1,n}) beyond at least one threshold value.

2. The method as claimed in claim 1, wherein, while the transmission is operating
at least one measured value or one measured value profile ((P1,n)*_{Sew,i}) is acquired periodically at the measuring point by means of the at least one electronic sensor apparatus at the least one triggering time at which at least two rotating transmission parts of the transmission are at a specific phase angle with respect to one another,
the time at which at least one specific observed tooth of a rotating transmission part in the form of a gearwheel passes the measuring point is also acquired electronically, and the number of the passes is stored in the counter memory in that the counter reading stored in the counter memory is increased by 1 whenever the tooth passes, and
ensemble averaging is carried out automatically for the acquired measured values or measured value profiles ((P1,n)*_{Sew,i}) in that after each increase in the counter reading the sum of the measured values or each measured value of the summed measured value profile ((P1,n)*_{Sew,i}) is divided by the counter reading representing the number of passes, in order in this way to determine the ensemble average (<s(w)_{ref}>_{P1,n}) for the measuring point and the observed tooth.

3. The method as claimed in claim 1, wherein a deformation and/or solid-borne sound is measured at the measuring point by means of the at least one sensor apparatus.

4. The method as claimed in claim 1, wherein the triggering time is selected on the basis of a phase angle of at least two rotating transmission parts of the transmission with respect to one another;
wherein the triggering time is specified by the phase angle of an output shaft and of an input shaft of the transmission.

5. (canceled)

6. The method as claimed in claim 1, wherein the triggering time is specified by means of a phase-determining sensor system which has at least one additional sensor apparatus.

7. The method as claimed in claim 6, wherein the phase-determining sensor system comprises at least one sensor means, as part of the sensor apparatus, which sensor means is assigned to a shaft or to a gearwheel of the transmission.

8. The method as claimed in claim 6, wherein a triggering time is defined for the observed tooth at a position of rest of the transmission, at which position the observed tooth bears, at the measuring point, against another tooth of the transmission part which is provided with the at least one sensor apparatus.

9. The method as claimed in claim 4, wherein the phase-determining sensor system contains at least one marking means, which can be detected by sensors, on each shaft or each gearwheel and at least one reading sensor means (PSs1).

10. The method as claimed in claim 1, wherein
after a comparison of the ensemble average (<s(w)>*_{P1,n}) with the at least one reference value or reference profile (<s(w)_{ref}>_{P1,n}) it is checked whether the counter reading exceeds a stored forgetting factor, and in the event of the counter reading being higher than the forgetting factor, the sum of the measured values or the summed measured value profile ((P1,n)_{Sew,i}), along with the counter reading, are set to zero before the next triggering time, or
the respective sum used for the ensemble averaging is always formed by means of a current data set which contains a specific number of last-acquired measured values or measured value profiles (<s(w)_{ref}>*_{P1,n}) wherein, when a new measured value or measured value profile (<s(w)_{ref}>_{P1,n}) is acquired for a measuring point, the oldest measured value or measured value profile of the data set used for this measuring point is replaced by the newly detected measured value or measured value profile (<s(w)_{ref}>_{P1,n}).

11. The method as claimed in claim 1, wherein the reference value or reference profile (<s(w)_{ref}>*_{P1,n}) was determined by ensemble averaging for the measuring point at the triggering time by means of the electronic sensor apparatus for a specified reference time period of the transmission.

12. The method as claimed in claim 1, wherein the measuring point is specified on a fixed ring gear of a transmission configured as an epicyclic transmission.

13. The method as claimed in claim 1, wherein by means of the evaluation logic it is possible to detect, on the basis of the ensemble average (<s(w)>*_{P1,n}),
damage and/or wear on a tooth edge of a tooth of a planetary gear of an epicyclic transmission and/or
damage and/or wear on a tooth edge of a tooth of a sun gear of an epicyclic transmission and/or
an imbalance of a planetary shaft on which a planetary gear of an epicyclic transmission is rotatably mounted and/or
an imbalance of a sun shaft which is connected in a rotationally fixed fashion to a sun gear of an epicyclic transmission and/or
unequal loading of various planetary gears of an epicyclic transmission;
wherein the determination of damage, wear and/or imbalance takes place in an epicyclic transmission of an engine, in particular of a gas turbine engine.

14. The method as claimed in claim 1, wherein a plurality of electronic sensor apparatuses is provided at different measuring points on the same transmission part of the transmission, at each of which at least one measured value or one measured value profile ((P1,n)*_{Sew,i}) is repeatedly acquired at one or more triggering times, wherein the triggering times are different for the different measuring points.

15. The method as claimed in claim 14, wherein
the time at which a specific tooth of a plurality of observed teeth of different rotating gearwheels passes the assigned measuring point is acquired electronically for the different measuring points, and the number of passes is stored in an associated counter memory for each observed tooth, in that a counter reading, stored in the counter memory, for this tooth is increased by 1 whenever the associated measuring points are passed by the respective tooth, and
ensemble averaging is carried out automatically for the acquired measured values or measured value profiles ((P1,n)*_{Sew,i}) at each measuring point in that after each increase in the counter reading for the associated observed tooth the sum of the measured values or each measured value of the summed measured value profile ((P1,n)*_{Sew,i}) is divided by the number of passes of this tooth, in order in this way to determine the ensemble average (<s(w)_{ref}>*_{P1,n}) for the respective measuring point on the basis of the associated tooth.

16. The method as claimed in claim 12, wherein an electronic sensor device is provided on the fixed ring gear, for each planetary gear, meshing with the ring gear, of the epicyclic transmission.

17. The method as claimed in claim 14, wherein a first measured value or a first measured value profile is acquired for all the different measuring points on the transmission, and an average value or average value profile is formed from the first measured values or first measured value profiles acquired for the different measuring points, in order to average influence of the respectively observed teeth.

18. The method as claimed in claim 1, wherein measured values or measured value profiles for different tooth segments of the same observed tooth are acquired at a measuring point by means of the at least one electronic sensor device, wherein in each case the counter reading for the tooth comprising the tooth segments is used for the ensemble averaging for the different tooth segments.

19. (canceled)

20. A device for determining damage, wear and/or imbalance in a transmission configured as a gear transmission, in particular an epicyclic transmission, by means of at least one electronic sensor apparatus of the device, wherein
at least one measured value or measured value profile ((P1, n)_{Sew,i}, (P1,n)*_{Sew,i}) for a rotating transmission part of the transmission can be acquired periodically by means of the at least one electronic sensor apparatus at a measuring point on a transmission part of the transmission at at least one specified triggering time, while the epicyclic transmission is operating,
the device has an evaluation logic, by means of which measured values or measured value profiles ((P1,n)_{Sew,i}, (P1,n)*_{Sew,i}) for the measuring point which are acquired at successive triggering times are summed, and the sum of the measured values or a summed measured value profile is stored by means of a memory apparatus of the device,
the memory apparatus is configured and provided to store a counter reading, which is increased by 1 at a triggering time for the rotating transmission part, in a counter memory,
ensemble averaging can be carried out automatically for the acquired measured values or measured value profiles ((P1,n)_{Sew,i}, (P1,n)*_{Sew,i}) by means of the evaluation logic in that after each increase in the counter reading the sum of the measured values or each measured value of the summed measured value profile ((P1,n)_{Sew,i}, (P1,n)*_{Sew,i}) division is carried out by means of the counter reading in order in this way to determine an ensemble average (<s(w)_{ref}>_{P1,n}) for the measuring point which tends toward a finite value for the measured value components which correlate at the triggering time and which tends toward zero for the non-correlated measured value components, and
the ensemble average (<s(w)>*_{P1,n}) is comparable with at least one reference value or reference profile (<s(w)_{ref}>_{P1,n}) by means of the evaluation logic in order to output a message about any damage, excessive wear and/or imbalance which has occurred within the transmission in the event of a deviation of the ensemble average (<s(w)>*_{P1,n}) from the at least one reference value or reference profile (<s(w)_{ref}>_{P1,n}) beyond at least one threshold value.

21. The device as claimed in claim 20, wherein
at least one measured value or measured value profile ((P1,n)*_{Sew,i}) for a rotating transmission part of the epicyclic transmission can be acquired periodically by means of the at least one electronic sensor apparatus at the measuring point on a transmission part of the transmission, at which the at least two rotating transmission parts of the transmission are at a specific phase angle with respect to one another, at at least one specified triggering, while the transmission is operating.
the time at which at least one specific observed tooth of a rotating transmission part in the form of a gearwheel passes the measuring point can also be detected electronically by means of the device, wherein the memory apparatus is configured and provided to store the number of the passes as stored in the counter memory in that the counter reading stored in the counter memory is increased by 1 whenever the tooth passes.

22. A device utilizing the method of claim 1.
